(19) United States
(12) Patent Application Publication
(10) Pub. No.: US 2023/0374909 A1
(43) Pub. Date: Nov. 23, 2023

(54) STATIC FLUID PASSAGEWAYS FOR GAS TURBINE ENGINES HAVING A GRAPHENE PORTION

(71) Applicants: General Electric Company, Schenectady, NY (US); General Electric Deutschland Holding GmbH, Frankfurt (DE)

(72) Inventors: Ashish Sharma, Munich (DE); Antonio Guijarro Valencia, Munich (DE); Paolo Vanacore, Munich (DE); Scott Alan Schimmels, Miamisburg, OH (US)

(21) Appl. No.: 17/751,059

(22) Filed: May 23, 2022

(51) Int. Cl. F01D 9/06; F01D 25/00; F01D 25/10; F01D 25/18

(52) U.S. Cl. CPC F01D 9/065; F01D 25/005; F01D 25/10; F01D 25/18; F05D 2260/231; F05D 2260/60; F05D 2260/98; F05D 2300/224; B33Y 80/00

(57) ABSTRACT

A gas turbine engine is provided. The gas turbine engine includes a fan; a turbomachine operably coupled to the fan for driving the fan, the turbomachine comprising a compressor section, a combustion section, and a turbine section in serial flow order and together defining a core air flowpath; a static fluid passageway in thermal communication with a portion of the turbomachine; and one or more graphene layers coupled to a portion of the static fluid passageway. The one or more graphene layers include graphene or an allotrope thereof

### TECHNICAL FIELD

The present subject matter relates generally to a gas turbine engine, or more particularly to a gas turbine engine having static fluid passageways that supply a flow of fluid therethrough.

### BACKGROUND

A turbofan engine generally includes a fan having a plurality of fan blades and a turbomachine arranged in flow communication with one another. Additionally, the turbomachine of the turbofan engine generally includes, in serial flow order, a compressor section, a combustion section, a turbine section, and an exhaust section. In operation, air is provided from the fan to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gasses through the turbine section drives the turbine section and is then routed through the exhaust section, e.g., to atmosphere.

Turbofan engines include passageways that supply fluid from one place to another. As the fluid travels through the passageway the fluid may lose heat which can reduce the efficiency of the engine, e.g., a flow rate of the fluid through the passageway.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic cross-sectional view of an exemplary gas turbine engine according to an exemplary embodiment of the present subject matter.

FIG. 2A is a close-up, schematic view of a static fluid passageway of the exemplary gas turbine engine of FIG. 1 having one or more graphene layers coupled to an external surface according to an exemplary embodiment of the present subject matter.

FIG. 2B is a close-up, schematic view of a static fluid passageway of the exemplary gas turbine engine of FIG. 1 having one or more graphene layers coupled to an interior surface according to another exemplary embodiment of the present subject matter.

FIG. 3 is a schematic view of a portion of a turbomachine of a turbofan engine including static fluid passageways having one or more graphene layers coupled thereto according to another exemplary embodiment of the present subject matter.

FIG. 4 is a schematic view of a portion of a turbomachine of a turbofan engine including static fluid passageways having one or more graphene layers coupled thereto and an electrical system according to another exemplary embodiment of the present subject matter.

FIG. 5 provides a block diagram of a control system for controlling a gas turbine engine in accordance with exemplary embodiments of the present disclosure.

FIG. 6 is an example computing system according to exemplary embodiments of the present disclosure.

Corresponding reference characters indicate corresponding parts throughout the several views. The exemplifications set out herein illustrate exemplary embodiments of the disclosure, and such exemplifications are not to be construed as limiting the scope of the disclosure in any manner.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The following description is provided to enable those skilled in the art to make and use the described embodiments contemplated for carrying out the disclosure. Various modifications, equivalents, variations, and alternatives, however, will remain readily apparent to those skilled in the art. Any and all such modifications, variations, equivalents, and alternatives are intended to fall within the scope of the present disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

For purposes of the description hereinafter, the terms “vertical”, “horizontal”, “longitudinal”, and derivatives thereof shall relate to the disclosure as it is oriented in the drawing figures. However, it is to be understood that the disclosure may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

As used herein, the terms “first”, “second”, and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The singular forms “a”, “an”, and “the” include plural references unless the context clearly dictates otherwise.

Additionally, the terms “low,” “high,” or their respective comparative degrees (e.g., lower, higher, where applicable) each refer to relative speeds or pressures within an engine, unless otherwise specified. For example, a “low-pressure turbine” operates at a pressure generally lower than a “high-pressure turbine.” Alternatively, unless otherwise specified, the aforementioned terms may be understood in their superlative degree. For example, a “low-pressure turbine” may refer to the lowest maximum pressure turbine within a turbine section, and a “high-pressure turbine” may refer to the highest maximum pressure turbine within the turbine section. An engine of the present disclosure may also include an intermediate pressure turbine, e.g., an engine having three spools.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin. These approximating margins may apply to a single value, either or both endpoints defining numerical ranges, and/or the margin for ranges between endpoints.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

The present disclosure is generally related to static fluid passageways of a gas turbine engine provided with one or more graphene layers to protect the static fluid passageways from losing thermal heat. It is contemplated that graphene or any similar material, e.g., carbon allotropes, carbon nanotubes, fullerene, or other similar material, may be used in this manner to protect the static fluid passageways from losing thermal heat. In this manner, the one or more graphene layers coupled to the static fluid passageways improve the static fluid passageways thermal management by: (1) saving air, oil, fuel thermal energy; (2) improving the life of the static fluid passageways; (3) improving engine performance; (4) reducing the maintenance of the static fluid passageways; and/or (5) reducing any air, oil, fuel leakage. It is further contemplated that a heat retention assembly of the present disclosure includes a static fluid passageway provided with one or more graphene layers that protect the static fluid passageway from losing thermal heat.

In further exemplary embodiments of the present disclosure, an electrical heating element is disposed in thermal communication with the graphene layers. The electrical heating element provides heat to a static fluid passageway and a fluid therein. In this manner, applying heat to a highly viscous fluid, such as oil, improves the flow rate of the oil through an oil supply channel.

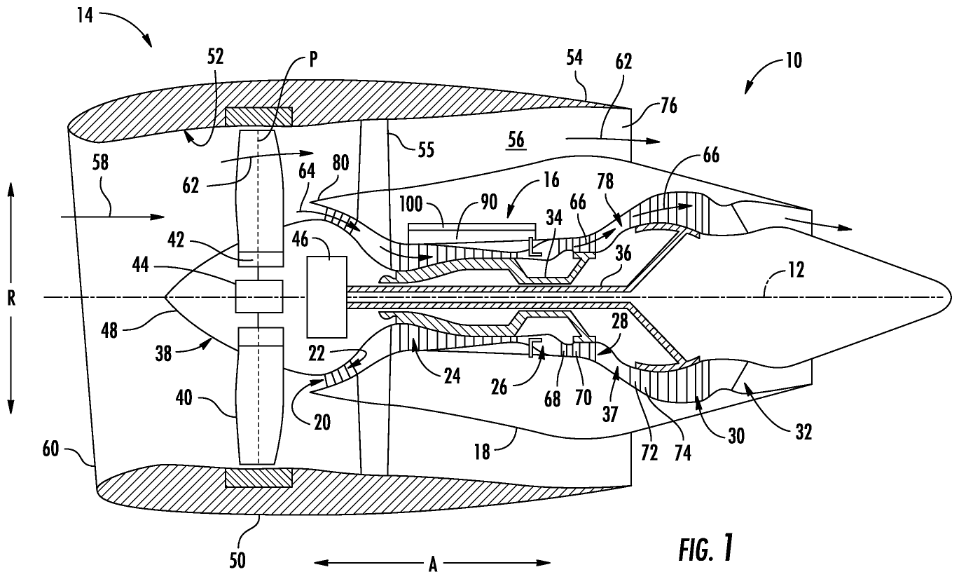

Referring now to the drawings, wherein identical numerals indicate the same elements throughout the figures, FIG. 1 is a schematic cross-sectional view of a gas turbine engine in accordance with an exemplary embodiment of the present disclosure. More particularly, for the embodiment of FIG. 1, the gas turbine engine is an aeronautical, turbofan jet engine 10, referred to herein as “turbofan engine 10”, configured to be mounted to an aircraft, such as in an under-wing configuration or tail-mounted configuration. As shown in FIG. 1, the turbofan engine 10 defines an axial direction A (extending parallel to a longitudinal centerline 12 provided for reference), a radial direction R, and a circumferential direction (i.e., a direction extending about the axial direction A; not depicted). In general, the turbofan engine 10 includes a fan section 14 and a turbomachine 16 disposed downstream from the fan section 14 (the turbomachine 16 sometimes also, or alternatively, referred to as a “core turbine engine”).

The exemplary turbomachine 16 depicted generally includes a substantially tubular outer casing 18 that defines an annular inlet 20. The outer casing 18 encases, in serial flow relationship, a compressor section including a first, booster or low pressure (LP) compressor 22 and a second, high pressure (HP) compressor 24; a combustion section 26; a turbine section including a first, high pressure (HP) turbine 28 and a second, low pressure (LP) turbine 30; and a jet exhaust nozzle section 32. A high pressure (HP) shaft 34 drivingly connects the HP turbine 28 to the HP compressor 24. A low pressure (LP) shaft 36 drivingly connects the LP turbine 30 to the LP compressor 22. The compressor section, combustion section 26, turbine section, and jet exhaust nozzle section 32 are arranged in serial flow order and together define a core air flowpath 37 through the turbomachine 16. It is also contemplated that the present disclosure is compatible with an engine having an intermediate pressure turbine, e.g., an engine having three spools.

Referring still the embodiment of FIG. 1, the fan section 14 includes a variable pitch, single stage fan 38, the turbomachine 16 operably coupled to the fan 38 for driving the fan 38. The fan 38 includes a plurality of rotatable fan blades 40 coupled to a disk 42 in a spaced apart manner. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable actuation member 44 configured to collectively vary the pitch of the fan blades 40, e.g., in unison. The fan blades 40, disk 42, and actuation member 44 are together rotatable about the longitudinal centerline 12 by LP shaft 36 across a power gear box 46. The power gear box 46 includes a plurality of gears for stepping down the rotational speed of the LP shaft 36 to a more efficient rotational fan speed. Accordingly, for the embodiment depicted, the turbomachine 16 is operably coupled to the fan 38 through the power gear box 46.

In exemplary embodiments, the fan section 14 includes twenty-two (22) or fewer fan blades 40. In certain exemplary embodiments, the fan section 14 includes twenty (20) or fewer fan blades 40. In certain exemplary embodiments, the fan section 14 includes eighteen (18) or fewer fan blades 40. In certain exemplary embodiments, the fan section 14 includes sixteen (16) or fewer fan blades 40. In certain exemplary embodiments, it is contemplated that the fan section 14 includes other number of fan blades 40 for a particular application.

Referring still to the exemplary embodiment of FIG. 1, the disk 42 is covered by rotatable front nacelle or hub 48 aerodynamically contoured to promote an airflow through the plurality of fan blades 40. Additionally, the exemplary fan section 14 includes an annular fan casing or outer nacelle 50 that at least partially, and for the embodiment depicted, circumferentially, surrounds the fan 38 and at least a portion of the turbomachine 16.

More specifically, the outer nacelle 50 includes an inner wall 52 and a downstream section 54 of the inner wall 52 of the outer nacelle 50 extends over an outer portion of the turbomachine 16 so as to define a bypass airflow passage 56 therebetween. Additionally, for the embodiment depicted, the outer nacelle 50 is supported relative to the turbomachine 16 by a plurality of circumferentially spaced outlet guide vanes 55.

During operation of the turbofan engine 10, a volume of air 58 enters the turbofan engine 10 through an associated inlet 60 of the outer nacelle 50 and/or fan section 14. As the volume of air 58 passes across the fan blades 40, a first portion of the air 58 as indicated by arrows 62 is directed or routed into the bypass airflow passage 56 and a second portion of the air 58 as indicated by arrow 64 is directed or routed into the core air flowpath 37. In the embodiment shown, an air splitter portion 80 divides these portions 62, 64 of the air 58. The ratio between an amount of airflow through the bypass airflow passage 56 (i.e., the first portion of air indicated by arrows 62) to an amount of airflow through the core air flowpath 37 (i.e., the second portion of air indicated by arrows 64) is known as a bypass ratio.

Referring still to FIG. 1, the compressed second portion of air indicated by arrows 64 from the compressor section mixes with fuel and is burned within the combustion section to provide combustion gases 66. The combustion gases 66 are routed from the combustion section 26, through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft 34, thus causing the HP shaft 34 to rotate, thereby supporting operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft 36, thus causing the LP shaft 36 to rotate, thereby supporting operation of the LP compressor 22 and/or rotation of the fan 38.

The combustion gases 66 are subsequently routed through the jet exhaust nozzle section 32 of the turbomachine 16 to provide propulsive thrust. Simultaneously, the pressure of the first portion of air indicated by arrows 62 is substantially increased as the first portion of air 62 is routed through the bypass airflow passage 56 before it is exhausted from a fan nozzle exhaust section 76 of the turbofan engine 10, also providing propulsive thrust. The HP turbine 28, the LP turbine 30, and the jet exhaust nozzle section 32 at least partially define a hot gas path 78 for routing the combustion gases 66 through the turbomachine 16.

Referring still to FIG. 1, the turbofan engine 10 additionally includes a static fluid passageway 90 that is in thermal communication with a portion of the turbomachine 16. Furthermore, one or more graphene layers 100 are coupled to, or integrated into, a portion of the static fluid passageway 90, as described in greater detail herein. As used herein, the term “static fluid passageway” refers to a passageway of the turbofan engine 10 that supplies fluid from one location to another location and that is non-rotating and static, i.e., there is no relative movement between the static fluid passageway and the turbomachine 16. As used herein, the term “coupled to” refers to two components being fixed to one another directly (e.g., through one or more mechanical fasteners or coupling devices), indirectly through one or more intermediate layers (such as a bond layer, e.g., a coating as described below), or through forming the components integrally (such as through an additive manufacturing method).

Moreover, it should be appreciated that the exemplary turbofan engine 10 depicted in FIG. 1 is by way of example only, and that in other exemplary embodiments, the turbofan engine 10 may have any other suitable configuration. For example, in certain exemplary embodiments, the fan may not be a variable pitch fan, the engine may not include a reduction gearbox (e.g., power gear box 46) driving the fan, may include any other suitable number or arrangement of shafts, spools, compressors, turbines, etc. It is also contemplated that the turbofan engine 10 may be an open rotor engine or any other similar configuration.

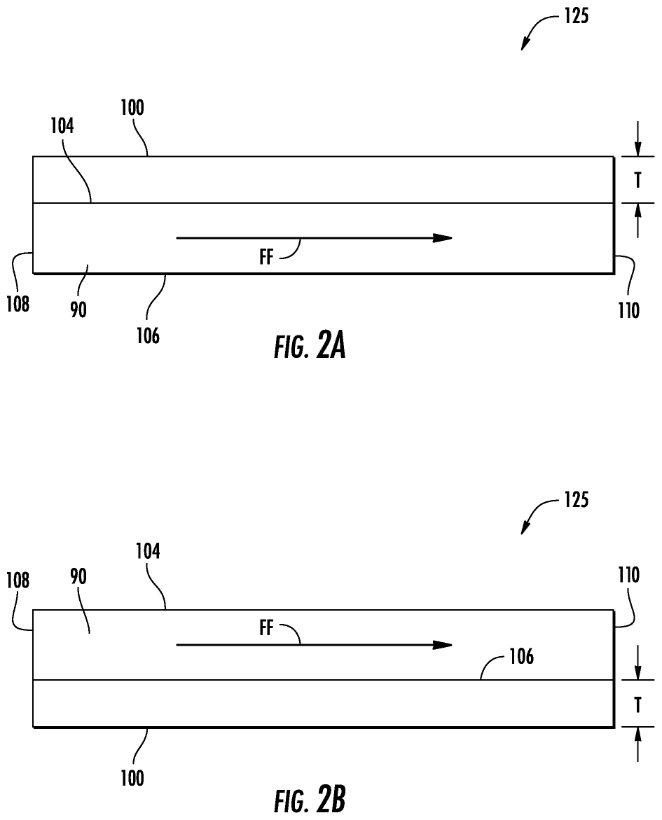

Referring now to FIG. 2A, a close-up, cross-sectional view of one or more graphene layers 100 coupled to a portion of a static fluid passageway 90 of the exemplary turbofan engine 10 of FIG. 1 is provided.

In such an embodiment, the static fluid passageway 90 provided with one or more graphene layers 100 of the present disclosure protects the static fluid passageway 90 from losing thermal heat. It is contemplated that graphene or any similar material, e.g., carbon allotropes, carbon nanotubes, fullerene, or other similar material, may be used in this manner to protect the static fluid passageway 90 from losing thermal heat. In this manner, the one or more graphene layers 100 coupled to the static fluid passageway 90 improve the static fluid passageway 90 thermal management by: (1) saving air, oil, fuel thermal energy; (2) improving the life of the static fluid passageway 90; (3) improving engine performance; (4) reducing the maintenance of the static fluid passageway 90; and/or (5) reducing any air, oil, fuel leakage. It is further contemplated that a heat retention assembly 125 of the present disclosure includes the static fluid passageway 90 provided with one or more graphene layers 100 that protect the static fluid passageway 90 from losing thermal heat.

Graphene is flexible, impermeable to molecules, and highly electrically and thermally conductive in one direction. For example, in one direction the graphene is highly electrically and thermally conductive, and in the other perpendicular direction the graphene is the opposite, e.g., low electrical and thermal conductivity. Furthermore, graphene combines the strength and light weight properties of the carbon network allotropes. The flexibility of graphene enables one or more graphene layers 100 to be coupled to the static fluid passageway 90 via an external coating. For example, in an exemplary embodiment, the one or more graphene layers 100 is coupled to a portion of a static fluid passageway 90 via an external coating as shown in FIG. 2A. The external coating may be an adhesive or the like with a temperature capability selected to withstand the anticipated temperatures of the heat retention assembly 125 during operation. The strength of graphene allows for reduced deterioration in a gas turbine environment. The lower weight of graphene reduces a weight added to a gas turbine engine for such a thermal heat loss prevention application.

Graphene has a melting temperature of about 5000 K (about 4727° C.) and has remarkable properties withstanding flame. The conductivity of graphene is anisotropic, and graphene can be used as an insulating material. Graphene also has better impact resistance than Kevlar. Conventional coatings that have a lower impact resistance cannot be applied to aero engines for these reasons. For example, engine components may be exposed to ingestion of foreign objects and airborne particles, for example, sand, dust, volcanic ash, ice crystals, snowflakes, super-cooled liquid droplets, hailstones, birds, insects, ice slabs, rain droplets, etc. Aero engines are also exposed to regular compressor washing procedures by water in order to clean internal turbomachinery and reobtain the compressor efficiency of clean surfaces. Advantageously, the graphene layers of the present disclosure are mechanically strong enough to resist the impact of such foreign objects and particles. Furthermore, the graphene layers of the present disclosure prevent erosion that is a typical issue of aero engines operating in particular in special environments with a high concentration of particles. Erosion is an issue that leads to replacing turbomachinery components at regular intervals. Avoiding these maintenance operations by using graphene, as described herein, thereby results in a financial benefit.

The high conductivity of graphene and the possibility of adapting to any existing structure given the high melting point of graphene make the incorporation of one or more graphene layers particularly useful for a static fluid passageway 90 of the turbofan engine 10 (FIG. 1) in high temperature environments and to protect the static fluid passageway 90 from losing thermal heat. Each of the graphene layers 100 is monoatomic and therefore minimally intrusive and can be piled.

Referring still to FIG. 2A, in an exemplary embodiment, the one or more graphene layers 100 define a thickness T of approximately 0.5 mil to approximately 50 mil. In certain exemplary embodiments, the one or more graphene layers 100 comprise a thickness T of approximately 1 mil to approximately 30 mil. In certain exemplary embodiments, the one or more graphene layers 100 comprise a thickness T of approximately 3 mil to approximately 20 mil.

In an exemplary embodiment, the one or more graphene layers 100 are coupled to an external surface 104 of the static fluid passageway 90. In exemplary embodiments, the external surface 104 of the static fluid passageway 90 is a surface that is exposed to ambient or a freeflow of air. Applying the one or more graphene layers 100 to an external surface 104 of the static fluid passageway 90 protects the static fluid passageway 90 from external atmospheric threats without adding excessive weight to the static fluid passageway 90. Furthermore, the one or more graphene layers 100 prevent erosion of the static fluid passageway 90.

Referring to FIG. 2B, a close-up, cross-sectional view of one or more graphene layers 100 coupled to, or integrated into, a portion of the static fluid passageway 90 of the exemplary turbofan engine 10 of FIG. 1 is provided. In another exemplary embodiment, the one or more graphene layers 100 are coupled to and/or integrated into an interior surface 106 of the static fluid passageway 90. The interior surface 106 is opposite the external surface 104 of the static fluid passageway 90.

Referring still to FIG. 2B, in an exemplary embodiment, the one or more graphene layers 100 define a thickness T of approximately 3 mil to approximately 100 mil. In certain exemplary embodiments, the one or more graphene layers 100 comprise a thickness T of approximately 3 mil to approximately 75 mil. In certain exemplary embodiments, the one or more graphene layers 100 comprise a thickness T of approximately 3 mil to approximately 50 mil. In certain exemplary embodiments, the one or more graphene layers 100 comprise a thickness T of approximately 3 mil to approximately 25 mil.

Referring to FIGS. 2A and 2B, in an exemplary embodiment, the static fluid passageway 90 extends between a first location 108 and a second location 110 and is configured to supply a flow of fluid FF from the first location 108 to the second location 110. Advantageously, the one or more graphene layers 100 are configured to retain heat within the static fluid passageway 90 as the flow of fluid FF travels from the first location 108 to the second location 110.

In one exemplary embodiment, a static fluid passageway 90 with one or more graphene layers 100 of the present disclosure is formed using precision casting, advanced machining, or other traditional manufacturing machines or methods. It is also contemplated that the application of the graphene layers may be applied to external hardware with multiple or single layers of graphene sheets, or can be applied as a spray coating. In one exemplary embodiment, a static fluid passageway 90 with one or more graphene layers 100 of the present disclosure is formed using additive manufacturing machines or methods. As described in detail below, exemplary embodiments of the formation of a static fluid passageway 90 with one or more graphene layers 100 involve the use of additive manufacturing machines or methods. As used herein, the terms “additively manufactured” or “additive manufacturing techniques or processes” refer generally to manufacturing processes wherein successive layers of material(s) are provided on each other to “build-up,” layer-by-layer, a three-dimensional component. The successive layers generally fuse together to form a monolithic component which may have a variety of integral sub-components.

Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or manufacturing technology. For example, embodiments of the present disclosure may use layer-additive processes, layer-subtractive processes, or hybrid processes.

Suitable additive manufacturing techniques in accordance with the present disclosure include, for example, Fused Deposition Modeling (FDM), Selective Laser Sintering (SLS), 3D printing such as by inkjets and laserjets, Sterolithography (SLA), Direct Selective Laser Sintering (DSLS), Electron Beam Sintering (EBS), Electron Beam Melting (EBM), Laser Engineered Net Shaping (LENS), Laser Net Shape Manufacturing (LNSM), Direct Metal Deposition (DMD), Digital Light Processing (DLP), Direct Selective Laser Melting (DSLM), Selective Laser Melting (SLM), Direct Metal Laser Melting (DMLM), and other known processes.

In addition to using a direct metal laser sintering (DMLS) or direct metal laser melting (DMLM) process where an energy source is used to selectively sinter or melt portions of a layer of powder, it should be appreciated that according to alternative embodiments, the additive manufacturing process may be a “binder jetting” process. In this regard, binder jetting involves successively depositing layers of additive powder in a similar manner as described above. However, instead of using an energy source to generate an energy beam to selectively melt or fuse the additive powders, binder jetting involves selectively depositing a liquid binding agent onto each layer of powder. The liquid binding agent may be, for example, a photo-curable polymer or another liquid bonding agent. Other suitable additive manufacturing methods and variants are intended to be within the scope of the present subject matter.

The additive manufacturing processes described herein may be used for forming a static fluid passageway 90 with one or more graphene layers 100 of the present disclosure using any suitable material. For example, the material may be plastic, metal, concrete, ceramic, polymer, epoxy, photopolymer resin, or any other suitable material that may be in solid, liquid, powder, sheet material, wire, or any other suitable form. More specifically, according to exemplary embodiments of the present subject matter, the additively manufactured components described herein may be formed in part, in whole, or in some combination of materials including but not limited to pure metals, nickel alloys, chrome alloys, titanium, titanium alloys, magnesium, magnesium alloys, aluminum, aluminum alloys, iron, iron alloys, stainless steel, and nickel or cobalt based superalloys (e.g., those available under the name Inconel® available from Special Metals Corporation). These materials are examples of materials suitable for use in the additive manufacturing processes described herein, and may be generally referred to as “additive materials.”

In addition, one skilled in the art will appreciate that a variety of materials and methods for bonding those materials may be used and are contemplated as within the scope of the present disclosure. As used herein, references to “fusing” may refer to any suitable process for creating a bonded layer of any of the above materials. For example, if an object is made from polymer, fusing may refer to creating a thermoset bond between polymer materials. If the object is epoxy, the bond may be formed by a crosslinking process. If the material is ceramic, the bond may be formed by a sintering process. If the material is powdered metal, the bond may be formed by a melting or sintering process. One skilled in the art will appreciate that other methods of fusing materials to make a component by additive manufacturing are possible, and the presently disclosed subject matter may be practiced with those methods.

In addition, the additive manufacturing process disclosed herein allows an integral static fluid passageway 90 with one or more graphene layers 100 to be formed from multiple materials. Thus, the components described herein may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although the components described herein may be constructed entirely by additive manufacturing processes, it should be appreciated that in alternate embodiments, all or a portion of these components may be formed via casting, machining, and/or any other suitable manufacturing process. Indeed, any suitable combination of materials and manufacturing methods may be used to form these components.

An exemplary additive manufacturing process will now be described. Additive manufacturing processes fabricate components using three-dimensional (3D) information, for example a three-dimensional computer model, of a static fluid passageway 90 with one or more graphene layers 100 of the present disclosure. Accordingly, a three-dimensional design model of the component may be defined prior to manufacturing. In this regard, a model or prototype of the component may be scanned to determine the three-dimensional information of the component. As another example, a model of a static fluid passageway 90 with one or more graphene layers 100 of the present disclosure may be constructed using a suitable computer aided design (CAD) program to define the three-dimensional design model of the component.

The design model may include 3D numeric coordinates of the entire configuration of a static fluid passageway 90 with one or more graphene layers 100 of the present disclosure including both external and internal surfaces of the component. For example, the design model may define the body, the surface, and/or internal passageways such as openings, support structures, etc. In one exemplary embodiment, the three-dimensional design model is converted into a plurality of slices or segments, e.g., along a central (e.g., vertical) axis of the component or any other suitable axis. Each slice may define a thin cross section of the component for a predetermined height of the slice. The plurality of successive cross-sectional slices together form the 3D component. The component is then “built-up” slice-by-slice, or layer-by-layer, until finished.

In this manner, a static fluid passageway 90 with one or more graphene layers 100 of the present disclosure described herein may be fabricated using the additive process, or more specifically each layer is successively formed, e.g., by fusing or polymerizing a plastic using laser energy or heat or by sintering or melting metal powder. For example, a particular type of additive manufacturing process may use an energy beam, for example, an electron beam or electromagnetic radiation such as a laser beam, to sinter or melt a powder material. Any suitable laser and laser parameters may be used, including considerations with respect to power, laser beam spot size, and scanning velocity. The build material may be formed by any suitable powder or material selected for enhanced strength, durability, and useful life, particularly at high temperatures.

Each successive layer may be, for example, between about 10 μm and 200 μm, although the thickness may be selected based on any number of parameters and may be any suitable size according to alternative embodiments. Therefore, utilizing the additive formation methods described above, the components described herein may have cross sections as thin as one thickness of an associated powder layer, e.g., 10 μm, utilized during the additive formation process.

In addition, utilizing an additive process, the surface finish and features of a static fluid passageway 90 with one or more graphene layers 100 of the present disclosure may vary as need depending on the application. For example, the surface finish may be adjusted (e.g., made smoother or rougher) by selecting appropriate laser scan parameters (e.g., laser power, scan speed, laser focal spot size, etc.) during the additive process, especially in the periphery of a cross-sectional layer which corresponds to the part surface. For example, a rougher finish may be achieved by increasing laser scan speed or decreasing the size of the melt pool formed, and a smoother finish may be achieved by decreasing laser scan speed or increasing the size of the melt pool formed. The scanning pattern and/or laser power can also be changed to change the surface finish in a selected area.

After fabrication of a static fluid passageway 90 with one or more graphene layers 100 of the present disclosure is complete, various post-processing procedures may be applied to the component. For example, post processing procedures may include removal of excess powder by, for example, blowing or vacuuming. Other post processing procedures may include a stress relief process. Additionally, thermal, mechanical, and/or chemical post processing procedures can be used to finish the part to achieve a desired strength, surface finish, and other component properties or features.

While the present disclosure is not limited to the use of additive manufacturing to form a static fluid passageway 90 with one or more graphene layers 100 of the present disclosure generally, additive manufacturing does provide a variety of manufacturing advantages, including ease of manufacturing, reduced cost, greater accuracy, etc.

Also, the additive manufacturing methods described above enable much more complex and intricate shapes and contours of a static fluid passageway 90 with one or more graphene layers 100 described herein to be formed with a very high level of precision. For example, such components may include thin additively manufactured layers, cross sectional features, and component contours. In addition, the additive manufacturing process enables the manufacture of an integral static fluid passageway 90 with one or more graphene layers 100 having different materials such that different portions of the component may exhibit different performance characteristics. The successive, additive nature of the manufacturing process enables the construction of these novel features. As a result, a static fluid passageway 90 with one or more graphene layers 100 of the present disclosure formed using the methods described herein may exhibit improved performance and reliability.

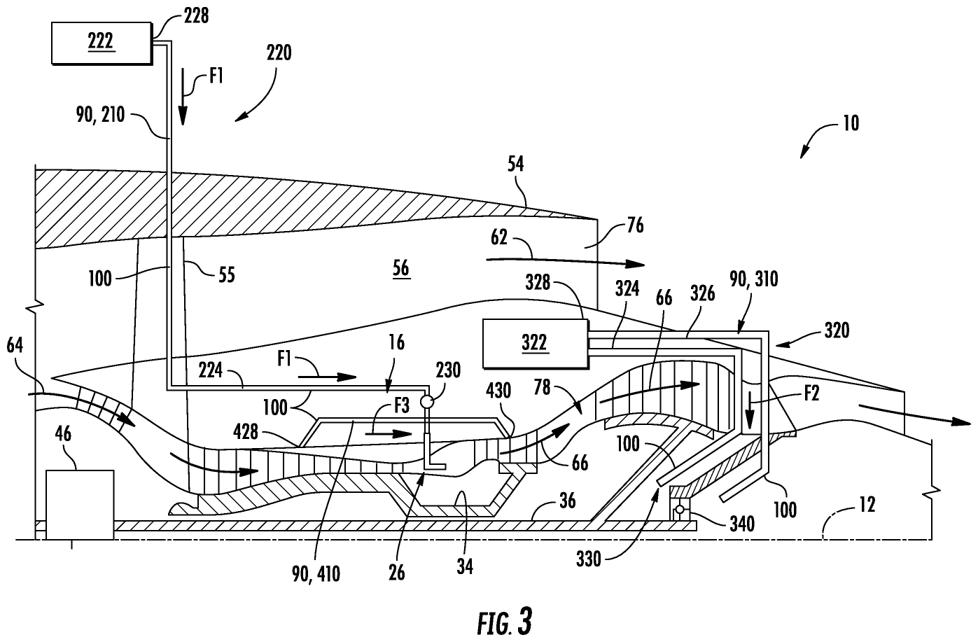

It is contemplated that the static fluid passageway 90 provided with one or more graphene layers 100 to protect the static fluid passageway 90 from losing thermal heat may include a variety of fluid passageways of the turbofan engine 10 (FIG. 1). For example, in exemplary embodiments of the present disclosure, referring now to FIG. 3, a close-up, schematic view of a portion of a turbomachine 16 of the turbofan engine 10 (FIG. 1) is provided.

In a first exemplary embodiment, the static fluid passageway 90 is a fuel supply channel 210 that is part of a fuel delivery system 220. The fuel delivery system 220 generally includes a fuel source 222, such as a fuel tank, and one or more fuel lines 224. The one or more fuel lines 224 provide a flow of fuel F1 through the fuel delivery system 220 to the combustion section 26 of the turbomachine 16 of the turbofan engine 10. It is contemplated that the fuel supply channel 210 may be one or more of the fuel lines 224 that provide a flow of fuel F1 through the fuel delivery system 220 to the combustion section 26 of the turbomachine 16.

In such an embodiment, the fuel supply channel 210 is provided with one or more graphene layers 100 that protect the fuel supply channel 210 from losing thermal heat. The fuel supply channel 210 extends between a first location 228 and a second location 230 and is configured to supply a flow of fuel F1 from the first location 228 to the second location 230. Advantageously, the one or more graphene layers 100 are configured to retain heat within the fuel supply channel 210 as the flow of fuel F1 travels from the first location 228 to the second location 230.

In a second exemplary embodiment, the static fluid passageway 90 is an oil supply channel 310 that is part of an oil delivery system 320. The oil delivery system 320 is configured to lubricate gear assemblies and turbomachinery shaft bearings or engine shafts. Lubricant, such as oil, is scavenged from a sump or a gearbox. For example, the oil delivery system 320 generally includes an oil source 322, a supply channel 324, and a return or scavenger channel 326. The supply channel 324 provides a flow of oil F2 to a bearing portion 340. Portions of the oil may be scavenged or returned to the oil source 322 via the return channel 326. It is contemplated that the oil delivery system 320 is compatible with any other gear assemblies, bearings, or shafts of the turbofan engine 10. It is contemplated that the oil supply channel 310 may include one or both of the supply channel 324 and the return channel 326 of the oil delivery system 320.

In such an embodiment, the oil supply channel 310 is provided with one or more graphene layers 100 that protect the oil supply channel 310 from losing thermal heat. The oil supply channel 310 extends between a first location 328 and a second location 330 and is configured to supply a flow of oil F2 from the first location 328 to the second location 330. Advantageously, the one or more graphene layers 100 are configured to retain heat within the oil supply channel 310 as the flow of oil F2 travels from the first location 328 to the second location 330.

In a third exemplary embodiment, the static fluid passageway 90 is a compressed air supply channel 410 that provides a flow of air F3 through the compressed air supply channel 410 to desired sections of the turbomachine 16 of the turbofan engine 10.

In such an embodiment, the compressed air supply channel 410 is provided with one or more graphene layers 100 that protect the compressed air supply channel 410 from losing thermal heat. The compressed air supply channel 410 extends between a first location 428 and a second location 430 and is configured to supply a flow of air F3 from the first location 428 to the second location 430. Advantageously, the one or more graphene layers 100 are configured to retain heat within the compressed air supply channel 410 as the flow of air F3 travels from the first location 428 to the second location 430.

In other exemplary embodiments, it is contemplated that other static fluid passageways that are in thermal communication with a portion of the turbomachine 16 may include the one or more graphene layers 100 coupled to, or integrated into, a portion of such static fluid passageways. For example, it is also contemplated that static fluid passageways having hydraulic fluid, two-phase fluid, thermal bus fluid, supercritical carbon dioxide (sC02), various types of refringent/cryogenic materials, or other fluids used in aero heat exchangers to transport heat from one location to another location may include the one or more graphene layers 100 coupled to, or integrated into, a portion of such static fluid passageways.

Furthermore, referring still to FIG. 3, in other exemplary embodiments, it is contemplated that the gas path internal surfaces of the combustion section 26 could include, or be made of, one or more graphene layers 100. Advantageously, based on its high melting temperature, graphene can sustain higher temperatures than existing metal alloys and CMC (Ceramic Matrix Composites) materials. The advantages of using a material with a higher melting temperature than existing materials include multiple advantages. The first advantage is to increase the gas turbine maximum temperature, this increases the gas turbines overall efficiency, meaning a reduced specific fuel consumption. The second advantage is to reduce the air flows used in the combustion section 26 to cool down the areas close to the solid internal surfaces. Reducing or removing cooling air flows (that are parasitic flows) increases the gas turbine efficiency. In particular, considering a novel combustor that burns hydrogen, higher temperatures can be achieved by using layers of graphene to protect the combustion section 26.

In other exemplary embodiments, it is also contemplated that the High Pressure Turbine stages, e.g., HP turbine stator vanes 68 and HP turbine rotor blades 70 (FIG. 1), are coated by one or more graphene layers 100. This arrangement protects the turbine stages from high temperatures. There are two advantages of this arrangement. First, at a given fixed combustor hot gases temperature, the air flow (parasitic flow) needed to cool down the HP turbine stator vanes 68 can be reduced or removed, which leads to increase the gas turbine efficiency. The other advantage is that the High Pressure Turbine stages can operate at a higher maximum temperature than is possible with conventional systems, again with a benefit of gas turbine efficiency and fuel consumption.

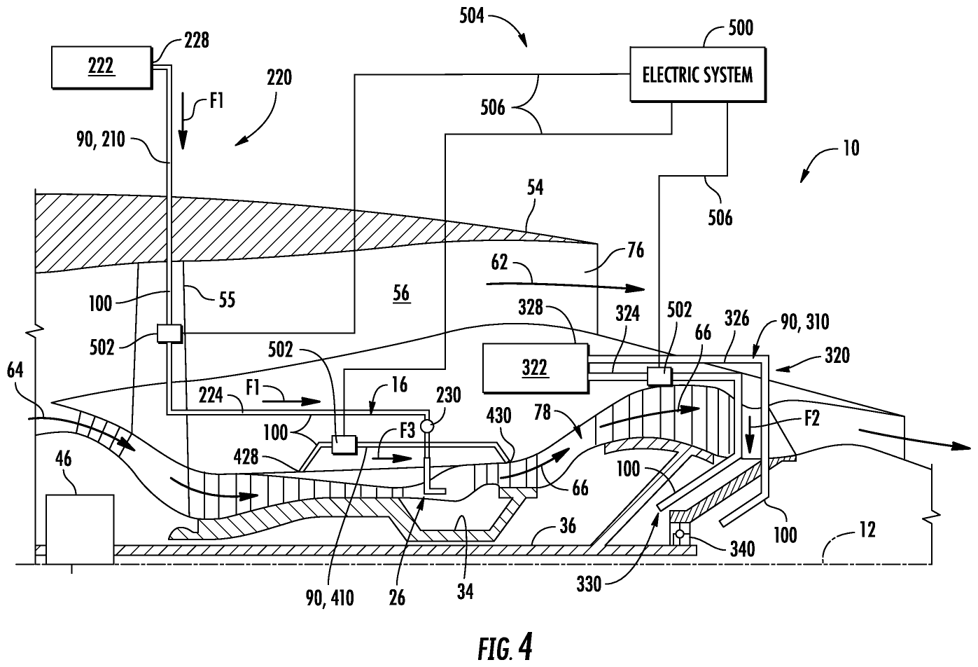

Referring now to FIG. 4, a close-up, schematic view of a portion of a turbomachine 16 of the turbofan engine 10 (FIG. 1) in accordance with another exemplary embodiment of the present disclosure is provided. The exemplary turbofan engine 10 of FIG. 4 may be configured in a similar manner as the exemplary engine of FIG. 1 described above. In the exemplary embodiment depicted, static fluid passageways 90 of the turbofan engine 10 are provided with one or more graphene layers 100 to protect the static fluid passageways 90 from losing thermal heat as described herein.

In an exemplary embodiment, the turbofan engine 10 also includes an electric system or electrical system 500 having electrical heating elements 502, an electrical supply assembly 504, and electrical supply cables 506. In an exemplary embodiment, the electrical heating elements 502 are disposed in thermal communication with the one or more graphene layers 100. For example, an electrical heating element 502 is disposed in thermal communication with the one or more graphene layers 100 at each of the fuel supply channel 210, the oil supply channel 310, and the compressed air supply channel 410.

In an exemplary embodiment, the electrical supply assembly 504 includes electrical supply cables 506 that are in electrical communication with the electrical heating elements 502. In this manner, the electrical supply cables 506 of the electrical system 500 provide power to the electrical heating elements 502 to heat the one or more graphene layers 100 at each of the fuel supply channel 210, the oil supply channel 310, and the compressed air supply channel 410. The electrical system 500 operates as a means to provide heat to the fuel supply channel 210, the oil supply channel 310, and the compressed air supply channel 410.

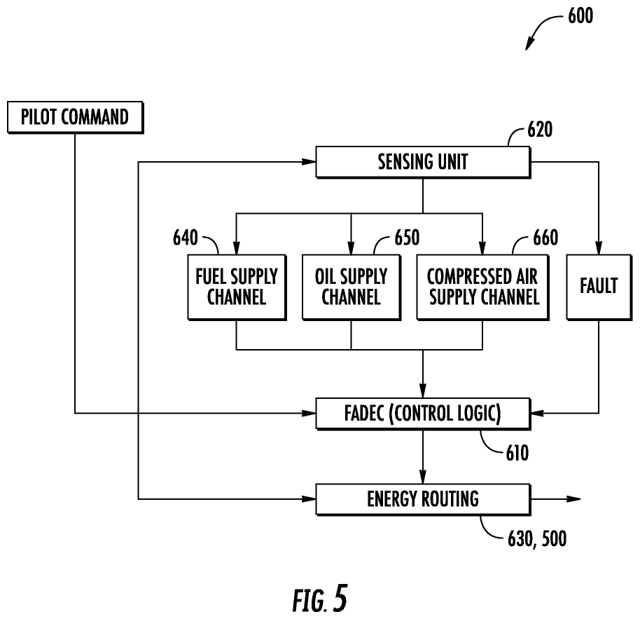

FIG. 5 provides a block diagram of an exemplary control system 600 for controlling a turbofan engine 10 (FIG. 1) in accordance with exemplary embodiments of the present disclosure.

Referring to FIG. 5, a control system 600 of the present disclosure may be in communication with the electrical system 500 (FIG. 4) of the turbofan engine 10. For example, the control system 600 may be used to determine when to start the electrical system 500 (FIG. 4) of the present disclosure to provide power to the electrical heating elements 502 (FIG. 4).

In some embodiments, all of the components of the control system 600 are onboard the turbofan engine 10. In other embodiments, some of the components of the control system 600 are onboard the turbofan engine 10 and some are offboard the turbofan engine 10. For instance, some of the offboard components can be mounted to a wing, fuselage, or other suitable structure of an aerial vehicle to which the turbofan engine 10 is mounted.

Referring to FIG. 5, the control system 600 includes a controller (e.g., control logic) 610, a sensing unit 620, and a power source (e.g., energy routing) 630. In an exemplary embodiment, the control system 600 is in communication with a fuel supply channel 640, an oil supply channel 650, and a compressed air supply channel 660. In an exemplary embodiment, the power source 630 is the electrical system 500. It is contemplated that the sensing unit 620 can include pressure and temperature sensors.

In an exemplary embodiment, the sensing unit 620 may include sensors at the components of the turbofan engine 10, e.g., the fuel supply channel 640, the oil supply channel 650, and the compressed air supply channel 660 that include the electrical heating elements 502 to heat the one or more graphene layers 100.

The sensing unit 620 of the control system 600 monitors conditions of the components of the turbofan engine 10, e.g., the fuel supply channel 640, the oil supply channel 650, and the compressed air supply channel 660. When the sensing unit 620 receives an input indicating a change in a condition of one of the components of the turbofan engine 10, the controller 610 causes the electrical supply assembly 504 of the electrical system 500 to provide power to the electrical heating elements 502. It is contemplated that the conditions of the components of the turbofan engine 10 that are monitored by the sensing unit 620 include temperature, pressure, and/or other information indicative of a fluid flow condition, pressure condition, and/or temperature condition of the components of the turbofan engine 10.

In an exemplary embodiment, when the sensing unit 620 receives an input indicating a change in a flow condition of the oil supply channel 650, the controller 610 causes the electrical supply assembly 504 of the electrical system 500 to provide power to the electrical heating element 502 at the oil supply channel 650 and heat to the oil supply channel 650 and the oil therein. In this manner, applying heat to a highly viscous fluid, such as oil, improves the flow rate of the oil through the oil supply channel 650.

In an exemplary embodiment, the turbofan engine 10 includes a computing system. Particularly, for this embodiment, the turbofan engine 10 includes a computing system having one or more computing devices, including a controller 610 configured to control the turbofan engine 10, and in this embodiment, the power source 630 and other components of the control system 600. The controller 610 can include one or more processor(s) and associated memory device(s) configured to perform a variety of computer-implemented functions and/or instructions (e.g., performing the methods, steps, calculations and the like and storing relevant data as disclosed herein). The instructions, when executed by the one or more processors, can cause the one or more processor(s) to perform operations, such as causing the electrical supply assembly 504 of the electrical system 500 to provide power to the electrical heating elements 502 upon receiving an input indicating a change in condition of one of the components of the turbofan engine 10.

Additionally, the controller 610 can include a communications module to facilitate communications between the controller 610 and various components of the aerial vehicle and other electrical components of the turbofan engine 10. The communications module can include a sensor interface (e.g., one or more analog-to-digital converters) to permit signals transmitted from the one or more sensors to be converted into signals that can be understood and processed by the one or more processor(s). It should be appreciated that the sensors can be communicatively coupled to the communications module using any suitable means. For example, the sensors can be coupled to the sensor interface via a wired connection. However, in other embodiments, the sensors can be coupled to the sensor interface via a wireless connection, such as by using any suitable wireless communications protocol. As such, the processor(s) can be configured to receive one or more signals or outputs from the sensors, such as one or more operating conditions/parameters.

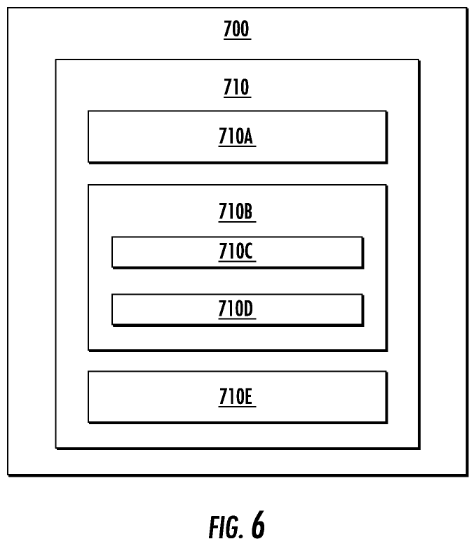

As used herein, the term “processor” refers not only to integrated circuits referred to in the art as being included in a computing device, but also refers to a controller, a microcontroller, a microcomputer, a programmable logic controller (PLC), an application specific integrated circuit, and other programmable circuits. The one or more processors can also be configured to complete the required computations needed to execute advanced algorithms. Additionally, the memory device(s) can generally include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) can generally be configured to store suitable computer-readable instructions that, when implemented by the processor(s), configure the controllers 610 to perform the various functions described herein. The controller 610 can be configured in substantially the same manner as the exemplary computing device of the computing system 700 described below with reference to FIG. 6.

The controller 610 may be a system of controllers or a single controller. The controller 610 may be a controller dedicated to control of the power source 630, the electrical system 500, and associated electrical components or can be an engine controller configured to control the turbofan engine 10 as well as the control system 600, and its associated electrical components. The controller 610 can be, for example, an Electronic Engine Controller (EEC) or an Electronic Control Unit (ECU) of a Full Authority Digital Engine Control (FADEC) system.

The control system 600 can include one or more power management electronics or electrical control devices, such as inverters, converters, rectifiers, devices operable to control the flow of electrical current, etc. For instance, one or more of the control devices can be operable to condition and/or convert electrical power (e.g., from AC to DC or vice versa). Further, one or more of the control devices can be operable to control the electrical power provided to the electrical system 500 by the power source 630. Although, the control devices may be separate from the power source 630 and the controller 610, it will be appreciated that one, some, or all of control devices can be located onboard the power source 630 and/or the controller 610.

As discussed, the turbofan engine 10 may also include one or more sensors for sensing and/or monitoring various engine operating conditions and/or parameters during operation. For instance, one or more sensors can be positioned at the fuel supply channel 640, one or more sensors can be positioned at the oil supply channel 650, one or more sensors can be positioned at the compressed air supply channel 660, among other possible locations. The sensors of the sensing unit 620 can sense or measure various engine conditions, e.g., pressures and temperatures, and one or more signals may be routed from the one or more sensors to the controller 610 for processing. Accordingly, the controller 610 is communicatively coupled with the one or more sensors, e.g., via a suitable wired or wireless communication link. It will be appreciated that the turbofan engine 10 can include other sensors at other suitable stations along the core air flowpath.

In an exemplary embodiment, the one or more sensors of the sensing unit 620 may monitor a flow condition, pressure, and/or temperature of the turbofan engine 10 and the controller 610 may be configured to provide power to the electrical system 500 once certain predetermined conditions of the components of the turbofan engine 10 have been reached. In exemplary embodiments, the one or more sensors of the sensing unit 620 may include resistance temperature detectors.

FIG. 6 provides an example computing system 700 according to example embodiments of the present disclosure. The computing systems (e.g., the controller 610) described herein may include various components and perform various functions of the computing system 700 described below, for example.

As shown in FIG. 6, the computing system 700 can include one or more computing device(s) 710. The computing device(s) 710 can include one or more processor(s) 710A and one or more memory device(s) 710B. The one or more processor(s) 710A can include any suitable processing device, such as a microprocessor, microcontroller, integrated circuit, logic device, and/or other suitable processing device. The one or more memory device(s) 710B can include one or more computer-readable media, including, but not limited to, non-transitory computer-readable media, RAM, ROM, hard drives, flash drives, and/or other memory devices.

The one or more memory device(s) 710B can store information accessible by the one or more processor(s) 710A, including computer-readable instructions 710C that can be executed by the one or more processor(s) 710A. The instructions 710C can be any set of instructions that when executed by the one or more processor(s) 710A, cause the one or more processor(s) 710A to perform operations. In some embodiments, the instructions 710C can be executed by the one or more processor(s) 710A to cause the one or more processor(s) 710A to perform operations, such as any of the operations and functions for which the computing system 700 and/or the computing device(s) 710 are configured, operations for electrically assisting a turbomachine during transient operation, and/or any other operations or functions of the one or more computing device(s) 710. The instructions 710C can be software written in any suitable programming language or can be implemented in hardware. Additionally, and/or alternatively, the instructions 710C can be executed in logically and/or virtually separate threads on processor(s) 710A. The memory device(s) 710B can further store data 710D that can be accessed by the processor(s) 710A. For example, the data 710D can include models, databases, etc.

The computing device(s) 710 can also include a network interface 710E used to communicate, for example, with the other components of system 700 (e.g., via a network). The network interface 710E can include any suitable components for interfacing with one or more network(s), including for example, transmitters, receivers, ports, controllers, antennas, and/or other suitable components. One or more external devices, such as electrical control device(s), can be configured to receive one or more commands from the computing device(s) 710 or provide one or more commands to the computing device(s) 710.

A control system 600 of the present disclosure does not require a change to the mechanical hardware of an engine and facilities simple retrofit with existing engines.

It is contemplated that the turbomachines and methods of the present disclosure may be implemented on an aircraft, helicopter, automobile, boat, submarine, train, unmanned aerial vehicle or drone and/or on any other suitable vehicle. While the present disclosure is described herein with reference to an aircraft implementation, this is intended only to serve as an example and not to be limiting. One of ordinary skill in the art would understand that the turbomachines and methods of the present disclosure may be implemented on other vehicles without deviating from the scope of the present disclosure.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Although specific features of various embodiments may be shown in some drawings and not in others, this is for convenience only. In accordance with the principles of the present disclosure, any feature of a drawing may be referenced and/or claimed in combination with any feature of any other drawing.

Further aspects of the disclosure are provided by the subject matter of the following clauses:

A gas turbine engine comprising: a fan; a turbomachine operably coupled to the fan for driving the fan, the turbomachine comprising a compressor section, a combustion section, and a turbine section in serial flow order and together defining a core air flowpath; a static fluid passageway in thermal communication with a portion of the turbomachine; and one or more graphene layers coupled to a portion of the static fluid passageway.

The gas turbine engine of any preceding clause, wherein the static fluid passageway extends between a first location and a second location and is configured to supply a flow of fluid from the first location to the second location, and wherein the one or more graphene layers are configured to retain heat within the static fluid passageway as the flow of fluid travels from the first location to the second location.

The gas turbine engine of any preceding clause, wherein the static fluid passageway is an oil supply channel.

The gas turbine engine of any preceding clause, wherein the static fluid passageway is a fuel supply channel.

The gas turbine engine of any preceding clause, wherein the static fluid passageway is a compressed air supply channel.

The gas turbine engine of any preceding clause, wherein the static fluid passageway extends between a first location and a second location and is configured to supply a flow of fluid from the first location to the second location, wherein the static fluid passageway includes an external surface, and wherein the one or more graphene layers cover the external surface of the static fluid passageway from the first location to the second location.

The gas turbine engine of any preceding clause, wherein the one or more graphene layers comprise a thickness of approximately 1 mil to approximately 30 mil.

The gas turbine engine of any preceding clause, wherein the one or more graphene layers comprise a thickness of approximately 3 mil to approximately 20 mil.

The gas turbine engine of any preceding clause, wherein the one or more graphene layers are coupled to the static fluid passageway via an external coating.

The gas turbine engine of any preceding clause, wherein the one or more graphene layers are formed integrally with the static fluid passageway via an additive manufacturing process.

The gas turbine engine of any preceding clause, further comprising an electrical heating element disposed in thermal communication with the one or more graphene layers; and an electrical supply assembly comprising an electrical supply cable in electrical communication with the electrical heating element.

The gas turbine engine of any preceding clause, further comprising a controller having one or more processors and one or more memory devices, the one or more memory devices storing instructions that when executed by the one or more processors cause the one or more processors to perform operations, in performing the operations, the one or more processors are configured to: receive an input indicating a change in a condition of the static fluid passageway; and in response to the change in the condition, cause the electrical supply assembly to provide power to the electrical heating element.

A heat retention assembly for a gas turbine engine, the gas turbine engine comprising a fan, a turbomachine operably coupled to the fan for driving the fan, the turbomachine including a compressor section, a combustion section, and a turbine section in serial flow order and together defining a core air flowpath, the heat retention assembly comprising: a static fluid passageway in thermal communication with a portion of the turbomachine when the heat retention assembly is installed in the gas turbine engine; and one or more graphene layers coupled to a portion of the static fluid passageway.

The heat retention assembly of any preceding clause, wherein the static fluid passageway extends between a first location and a second location and is configured to supply a flow of fluid from the first location to the second location, and wherein the one or more graphene layers are configured to retain heat within the static fluid passageway as the flow of fluid travels from the first location to the second location.

The heat retention assembly of any preceding clause, wherein the static fluid passageway is an oil supply channel.

The heat retention assembly of any preceding clause, wherein the static fluid passageway is a fuel supply channel.

The heat retention assembly of any preceding clause, wherein the static fluid passageway is a compressed air supply channel.

The heat retention assembly of any preceding clause, wherein the static fluid passageway extends between a first location and a second location and is configured to supply a flow of fluid from the first location to the second location, wherein the static fluid passageway includes an external surface, and wherein the one or more graphene layers cover the external surface of the static fluid passageway from the first location to the second location.

The heat retention assembly of any preceding clause, wherein the one or more graphene layers comprise a thickness of approximately 1 mil to approximately 30 mil.

The heat retention assembly of any preceding clause, further comprising an electrical heating element disposed in thermal communication with the one or more graphene layers; an electrical supply assembly comprising an electrical supply cable in electrical communication with the electrical heating element; and a controller having one or more processors and one or more memory devices, the one or more memory devices storing instructions that when executed by the one or more processors cause the one or more processors to perform operations, in performing the operations, the one or more processors are configured to: receive an input indicating a change in a condition of the static fluid passageway; and in response to the change in the condition, cause the electrical supply assembly to provide power to the electrical heating element.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

While this disclosure has been described as having exemplary designs, the present disclosure can be further modified within the scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A gas turbine engine comprising:
a fan;
a turbomachine operably coupled to the fan for driving the fan, the turbomachine comprising a compressor section, a combustion section, and a turbine section in serial flow order and together defining a core air flowpath;
a static fluid passageway in thermal communication with a portion of the turbomachine; and
one or more graphene layers coupled to a portion of the static fluid passageway.

2. The gas turbine engine of claim 1, wherein the static fluid passageway extends between a first location and a second location and is configured to supply a flow of fluid from the first location to the second location, and wherein the one or more graphene layers are configured to retain heat within the static fluid passageway as the flow of fluid travels from the first location to the second location.

3. The gas turbine engine of claim 1, wherein the static fluid passageway is an oil supply channel.

4. The gas turbine engine of claim 1, wherein the static fluid passageway is a fuel supply channel.

5. The gas turbine engine of claim 1, wherein the static fluid passageway is a compressed air supply channel.

6. The gas turbine engine of claim 1, wherein the static fluid passageway extends between a first location and a second location and is configured to supply a flow of fluid from the first location to the second location, wherein the static fluid passageway includes an external surface, and wherein the one or more graphene layers cover the external surface of the static fluid passageway from the first location to the second location.

7. The gas turbine engine of claim 1, wherein the one or more graphene layers comprise a thickness of approximately 1 mil to approximately 30 mil.

8. The gas turbine engine of claim 1, wherein the one or more graphene layers comprise a thickness of approximately 3 mil to approximately 20 mil.

9. The gas turbine engine of claim 1, wherein the one or more graphene layers are coupled to the static fluid passageway via an external coating.

10. The gas turbine engine of claim 1, wherein the one or more graphene layers are formed integrally with the static fluid passageway via an additive manufacturing process.

11. The gas turbine engine of claim 1, further comprising:
an electrical heating element disposed in thermal communication with the one or more graphene layers; and
an electrical supply assembly comprising an electrical supply cable in electrical communication with the electrical heating element.

12. The gas turbine engine of claim 11, further comprising:
a controller having one or more processors and one or more memory devices, the one or more memory devices storing instructions that when executed by the one or more processors, cause the one or more processors to perform operations, in performing the operations, the one or more processors are configured to:
receive an input indicating a change in a condition of the static fluid passageway; and
in response to the change in the condition, cause the electrical supply assembly to provide power to the electrical heating element.

13. The gas turbine engine of claim 1, wherein the one or more graphene layers comprise graphene or an allotrope thereof

14. A heat retention assembly for a gas turbine engine, the gas turbine engine comprising a fan, a turbomachine operably coupled to the fan for driving the fan, the turbomachine including a compressor section, a combustion section, and a turbine section in serial flow order and together defining a core air flowpath, the heat retention assembly comprising:
a static fluid passageway in thermal communication with a portion of the turbomachine when the heat retention assembly is installed in the gas turbine engine; and
one or more graphene layers coupled to a portion of the static fluid passageway.

15. The heat retention assembly of claim 14, wherein the static fluid passageway extends between a first location and a second location and is configured to supply a flow of fluid from the first location to the second location, and wherein the one or more graphene layers are configured to retain heat within the static fluid passageway as the flow of fluid travels from the first location to the second location.

16. The heat retention assembly of claim 14, wherein the static fluid passageway is an oil supply channel.

17. The heat retention assembly of claim 14, wherein the static fluid passageway extends between a first location and a second location and is configured to supply a flow of fluid from the first location to the second location, wherein the static fluid passageway includes an external surface, and wherein the one or more graphene layers cover the external surface of the static fluid passageway from the first location to the second location.

18. The heat retention assembly of claim 14, wherein the one or more graphene layers comprise a thickness of approximately 1 mil to approximately 30 mil.

19. The heat retention assembly of claim 14, further comprising:
an electrical heating element disposed in thermal communication with the one or more graphene layers;
an electrical supply assembly comprising an electrical supply cable in electrical communication with the electrical heating element; and
a controller having one or more processors and one or more memory devices, the one or more memory devices storing instructions that when executed by the one or more processors, cause the one or more processors to perform operations, in performing the operations, the one or more processors are configured to:
receive an input indicating a change in a condition of the static fluid passageway; and
in response to the change in the condition, cause the electrical supply assembly to provide power to the electrical heating element.

20. The heat retention assembly of claim 14, wherein the one or more graphene layers comprise graphene or an allotrope thereof
